(19) United States
(12) Patent Application Publication
(10) Pub. No.: US 2025/0303529 A1
(43) Pub. Date: Oct. 2, 2025

(54) TOOL FOR THREADED ADAPTERS AND FASTENERS

(71) Applicant: Eric Miller, Millbury, OH (US)

(72) Inventor: Eric Miller, Millbury, OH (US)

(21) Appl. No.: 18/647,573

(22) Filed: Apr. 26, 2024

Related U.S. Application Data
(60) Provisional application No. 63/570,594, filed on Mar. 27, 2024.

(51) Int. Cl. B25B 13/48; B25B 23/00; B25B 23/12

(52) U.S. Cl. CPC B25B 13/481; B25B 23/0035; B25B 23/12

(57) ABSTRACT

Devices, methods, and other embodiments associated with a tool for easily turning threaded fasteners, fittings, and adapters are described. In one embodiment, the tool includes a housing having a first end and a second end opposite to the first end and a plurality of vertical solid structures. Each of the plurality of vertical solid structures may be positioned to be adjacent to the first end of the housing and configured to extend from the first end to be received in an opening of a fastener, fitting, or adapter. The tool may include a bolt head positioned adjacent to the second end of the housing. The bolt head may be configured to be operably coupled to the housing and the plurality of vertical solid structures such that a rotation of the bolt head causes a rotation of the housing and the plurality of vertical solid structures.

### TECHNICAL FIELD

The embodiments generally relate to tools for loosening and tightening threaded hardware, components, and/or attachments, and more particularly, relates to a tool and method of making the tool, the tool facilitating easy fastening or loosening of threaded fasteners, adapters, fittings, fixtures, attachments and other hardware components, and the like.

### BACKGROUND

In the construction and building industry there are many tools and equipment available in the market to improve efficiency, minimize mechanical effort, or improve accuracy in a work project. In general, certain projects and repairs must meet building codes or otherwise an installation may need to be updated to meet such codes. These codes are additional mechanisms and precautions put in place to make an installation secure or stable in view of the conditions of the particular building or environment in which they are installed. For example, in certain regions a new installation on premises of a building or facility may need to pass an inspection or meet certain building or facility codes. As an example, a building equipment installation that requires plumbing or piping installation can often be difficult due to the location and access of the system. While there are a number of mechanical and electrical tools to make the installation more efficient that is not always the case. For example, certain construction or mechanical parts and components still require a makeshift process or an unsuitable tool. For example, installing a flange adapter may take considerable time and effort as there are no specific tools for tightening or loosening the flange adapter. Thus, installation of a flange adapter can often require unconventional positioning or posture in difficult to reach areas making the process of securing the flange adapter very time consuming if not painful. Moreover, some surfaces of the flange adapter can be fragile or brittle to twisting or bending motion that can damage the flange adapter and/or the threaded end of the piping on which it is installed. Therefore, it would be advantageous to have a tool that can easily operate to loosen or tighten parts/components like the flange adapter.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale. A complete understanding of the present embodiments and the advantages and features thereof will be more readily understood by reference to the following detailed description when considered in conjunction with the accompanying drawings wherein:

FIG. 1A illustrates a left plane view of one embodiment of a tool device that facilitates easy fastening or loosening of a fitting, adapter, fastener, and other components, parts, and hardware;

FIG. 1B illustrates one embodiment of a hardware component (e.g., flange adapter) that may be loosened or tightened using the tool device of FIG. 1A;

FIG. 1C illustrates a side plane view of one embodiment of a tool device configured for operating with the hardware component of FIG. 1B;

FIG. 1D illustrates a side plane view of one embodiment of a tool device configured for operating with the hardware component of FIG. 1B;

FIG. 1E illustrates a top plane view of one embodiment of an example tool for operating the tool device of FIG. 1C;

FIG. 1F illustrates a left perspective view of the tool device of FIG. 1C;

FIG. 2 illustrates one embodiment of the tool of FIG. 1A configured for the hardware component (e.g., flange adapter) of FIG. 1B to loosen or tighten the example hardware component on a threaded pipe;

FIG. 3 illustrates one embodiment of the example hardware component (e.g., flange adapter) of FIG. 1B being attached and tightened on an example system such as a pressure transmitter system; and

FIG. 4 illustrates one embodiment of a method of making the example tool devices disclosed that may be used with the example threaded fasteners, fittings, and adapters devices disclosed.

### DETAILED DESCRIPTION

Devices and methods are described herein as associated with a tool for threaded fasteners, fittings, adapters, and/or parts/components. The tool may include a housing having a first end and a second end opposite to the first end, a number of vertical solid structures positioned on the first end of the housing and configured to extend from the first end to be received in an opening of the fastener, fitting, adapter, and/or parts/component. The tool may further include an operating feature such as a bolt head positioned adjacent to the second end of the housing and operably coupled to the housing and the plurality of vertical solid structures such that a rotation of the operating feature causes a rotation of the housing and the plurality of vertical solid structures. Thus, the tool itself may be an adapter for unconventional parts/components that have irregular surfaces and/or features that cannot be operated on using conventional tools. The tool device and method of making as described herein solves these problems and others by facilitating an intermediary adapter, such as a socket adapter that can be operated using a socket wrench, ratchet, or the like, for example.

### Tool for Threaded Fittings and Attachments

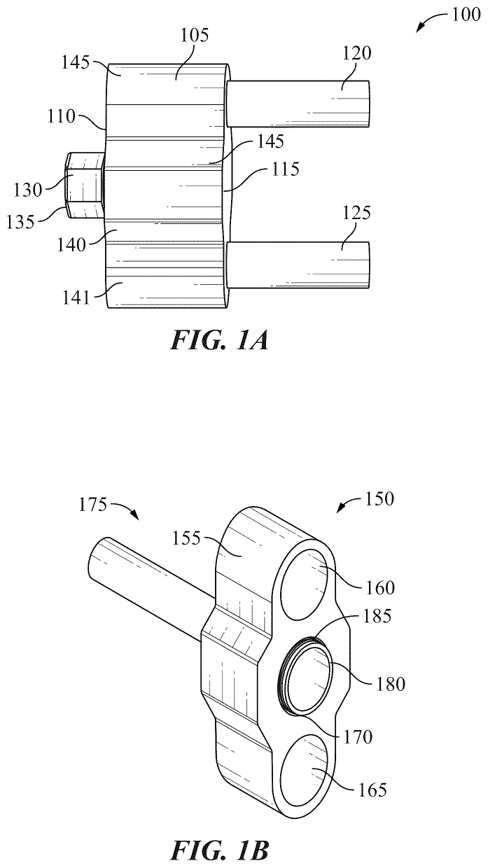

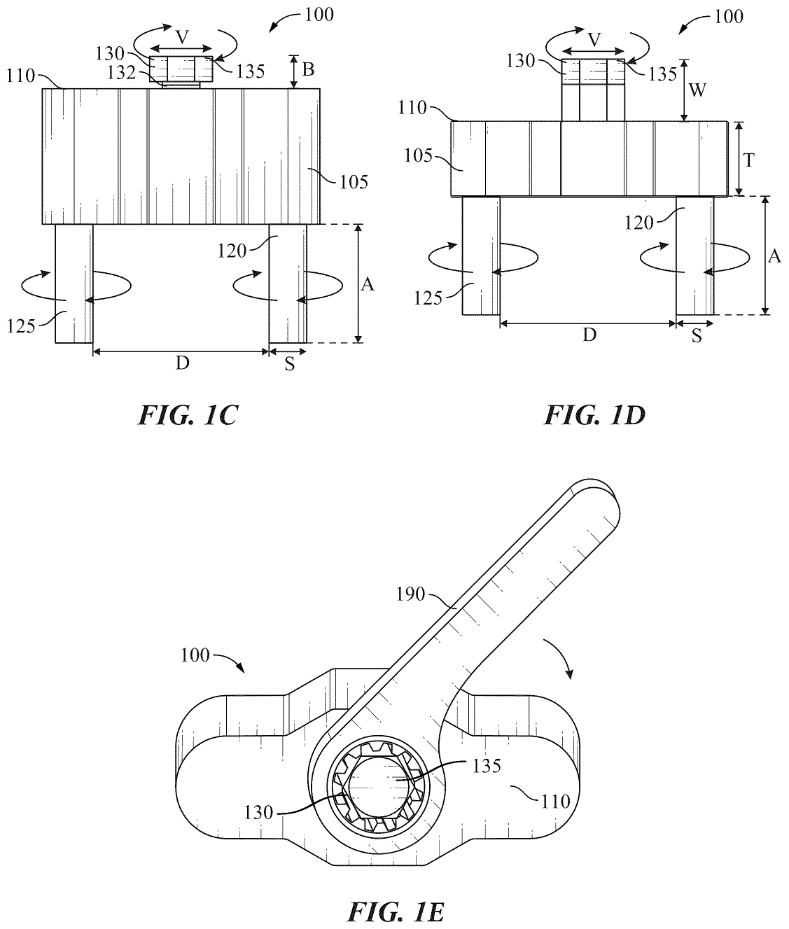

With reference to FIG. 1A, one embodiment of a tool device that facilitates easy fastening or loosening of a fitting, adapter, fastener, and other components, parts, and hardware will now be described. The tool device 100 includes a housing 105, an operating feature 130 and a plurality of vertical structures 120, 125. The housing 105 may include a first surface 110, a second surface 115, and one or more lateral surfaces 140, 141, 143, and 145 whereby the one or more lateral surfaces 140, 141, 143, and 145 extend outwards to connect the first surface 110 with the second surface 115. The plurality of vertical structures 120, 125 may be any polygonal shape, for example, cylindrical, rectangular, pyramidal to be received in a similarly shaped opening of a fitting, adapter, fastener, part, etc. The housing 105 may have a square, rectangular, of cylindrical shape to facilitate positioning of the tool device 100 on or into a receiving adapter, fastener, fitting, or part. In one embodiment, the housing 105 may be a fork-like structure whereby the first surface 110, the second surface 115, and the one or more lateral surfaces 140, 141, 143, and 145 form a rod or cylindrical structure that bridges and couples the operating feature 130 and the plurality of vertical structures 120, 125. Further, the operating feature 130 may extend outwards at 1 inch or more to facilitate coupling of a fastening tool such as a ratchet to a head 135 of the operating feature 130. Moreover, the plurality of vertical structures 120, 125 may extend outwards at 1 inch or more to facilitate coupling of the tool device 100 to an opening of a fitting, adapter, fastener, part/component.

In one embodiment, at least one of the first surface 110, the second surface 115, and the one or more of the lateral surfaces 140, 141, 143, and 145 may be flat, smooth, curved, or straight and rigid to facilitate ease in access and use of the operating feature 130, and the plurality of vertical structures 120, 125. In certain embodiments, the first surface 110, the second surface 115, and the one or more of the lateral surfaces 140, 141, 143, and 145 may be designed for strength and durability as needed. The housing 105, operating feature 130, and plurality of vertical structures 120, 125 may be formed as a unitary device, whereby the operating feature 130 allows a user to attached and engage a tool (e.g., wrench or ratchet) with the tool device 100 to operate the tool device as a socket piece, for example. In certain embodiments, the operating feature 130 may be a hexagonal or square bolt head, screw, or any type of fastener head that may be engaged with using a mechanical or electrical tool, for example, a ratchet, wrench, pliers, impact driver, drill, or the like. Further, the operating feature 130 can allow a user to attach a wrench to the tool device 100 and operate the tool device 100 to rotate and thereby rotating the plurality of vertical structures 120, 125.

In one embodiment, the tool device 100, and components thereof, such as the housing 105, the operating feature 130 and the plurality of vertical structures 120, 125 may be magnetic or made of rare earth and/or regular magnetic materials, for example, neodymium, samarium cobalt, alnico and ceramic or ferrite magnets. Example magnetic materials may include Nd₂Fe₁₄B, Nd₂Fe₁₄B, SmCo₅, Sm(Co,Fe,Cu,Zr)₇, Sr-ferrite, and Iron (Fe) bar magnet. Further, the tool device 100 may be plated or coated to protect them from breaking, chipping, corrosion, or crumbling into powder. As an example, one or more of the plurality of vertical structures 120, 125 may be made of neodymium, NdFeB. Further, the magnetic vertical structures 120, 125 may be coated with a layer of nickel followed by a layer of copper and then nickel again (Ni—Cu—Ni coating) to prevent damage or corrosion to the magnetic material. Further, the tool device 100, and components thereof, such as the housing 105, the operating feature 130 and the plurality of vertical structures 120, 125 may be fabricated from various metals, such as steel, steel alloy, cast iron, or any metal or metal alloy material disclosed herein.

In one embodiment, the tool device 100 may be fabricated using a casting process, followed by computer-aided machining to form a monolithic structure. In one embodiment, the tool device 100 may be made of molybdenum in combination with alloy steel and iron to provide desirable alloying qualities, for example, control of microstructure, improved hardenability, reduced temper embrittlement, resistance to hydrogen attack & sulfide stress cracking, and increased elevated temperature strength. Similarly, carbon steels may be used as the metallic material. Other types of metal alloys may be used, for example, nickel-based alloys, cobalt-based alloys, titanium-based alloys, and refractory metals. In certain embodiments, the tool device 100 may be made of steel alloys comprising at least one or more of the following metals, for example, Iron (Fe), Nickel (Ni), Chromium (Cr), Copper (Cu), Molybdenum (Mo), Silicon (Si), Carbon (C), Manganese (Mn), Phosphorous (P), Sulfur(S), Titanium (Ti), and Vanadium (V). Thus, the tool device 100 may be manufactured as desired using various metals and metal alloys to improve hardenability, density, durability, corrosion and wear resistance, cracking, and to prevent other types of damage and degradation.

With reference to FIG. 1B, one embodiment of a hardware component (e.g., flange adapter) that may be loosened or tightened using the tool device of FIG. 1A will now be described. An example hardware component that may be used with the tool device 100 includes a flange adapter 150. In many embodiments, the example flange adapter 150 includes a plurality of openings 160 and 165 positioned on a body 155 of the flange adapter 150 that cut through and traverse the body 155 of the flange adapter 150. In one embodiment, the plurality of openings 160 and 165 may be used to secure the flange adapter 150 onto and abutting a surface using, for example, metal fasteners (e.g., metal bolts). In order to secure the flange adapter 150 to a part/pipe or abut a surface, the flange adapter 150 includes a threaded opening 170 that receives and fastens to a threaded part, for example, a threaded pipe 175. The flange adapter 150 receives one end 180 of the threaded pipe 175 that includes a threaded surface 185 for engaging with and securing the flange adapter 150.

In general, a threaded part/component such as the flange adapter 150 is manually secured to the threaded pipe 175 using a wrench that grips and secures onto the body 155 of the flange adapter 150. The wrench is then used to rotate the body 155 of the flange adapter 150, that is, the body of the wrench rotates with the body 155 of the flange adapter 150 to loosen or tighten the flange adapter 150. However, in practice, securing a threaded part/component such as a flange adapter, for example, can take considerable time and effort requiring unconventional positioning or posture in difficult to reach areas making the process of securing the part/component very time consuming if not painful. Moreover, some surfaces of the part/component can be fragile or brittle to twisting or bending motion that can damage the part/component and/or the threaded end of the piping. With the tool device 100, a threaded part/component having one or more openings and/or irregular exterior surfaces may be tightened/loosened with ease by using the tool device 100 as a socket type adapter device that engages and secures to the part/component thereby allow a mechanical or electrical tools to be attached to the operating feature 130 to tighten/loosen the part/component.

With reference to FIGS. 1C-1E, one embodiment of a tool device for operating with the hardware component of FIG. 1B will now be described. The tool device 100 may be configured to include two vertical structures 120 and 125 that may be spaced apart by a distance “D” and may be configured to have a height “A” and a diameter “S”. In one embodiment, the distance “D” may be between 0.20 inches to 7 inches, the height “A” may be between 0.50 inches to 5 inches, and the diameter “S” may be between 0.30 inches to 4 inches. Moreover, the operating feature 130 may be configured to have a height “B” and a diameter “V”. In one embodiment, the height “B” may be between 0.50 inches to 11 inches, and the diameter “S” may be between 0.30 inches to 4 inches. In one embodiment, the operating feature 130 may include a neck 132, the neck 132 integrally connected to operating feature 130 and the body of housing 105, the neck 132 and the operating feature 130 forming the height “B”. As shown, the tool device 100 is a unitary piece, whereby a rotation of the operating head 135 of the operating feature 130 causes a rotation of the tool body 105 that causes a rotation of the two vertical structures 120 and 125. Referring to FIG. 1D, one embodiment of a tool device for operating with the hardware component of FIG. 1B may include a raised operating feature 130 (e.g., bolt head) raised by a height “W” having no neck, the raised operating feature 130 configured to be integrally formed into the body of housing 105. Moreover, the housing may be configured to have a height “T”. In one embodiment, the height “W” may be between 0.20 inches to 7 inches, the height “T” may be between 0.50 inches to 5 inches. Referring to FIG. 1E, an example tool for operating the tool device of FIG. 1C will now be described. The tool device 100 may be operated/rotated using a mechanical tool such as a ratchet 190, for example. The ratchet 190 attaches to the operating head 135 of the operating feature 130 positioned on the first surface 110 or first end of the tool device 100. Thus, a rotation of the ratchet 190 causes rotation of the operating head 135 and rotation of the tool device 100.

With reference to FIG. 1F, one embodiment of a tool device for operating with the hardware component of FIG. 1B will now be described. In one embodiment, the tool device 100 may include a recess 129 positioned on the second surface 115 or second end of the housing 105 to protect the second surface 115 of the tool device 100 from contacting and damaging an end 180 of a threaded pipe 175 during tightening or loosening of the flange adapter 150. Moreover, the recess 129 may be configured to have a diameter “C” and a depth of 0.01 inch to 1 inch. In one embodiment, the diameter “D” may be between 0.30 inches to 4 inches. Moreover, the recess 129 may be positioned between the vertical structures 120 and 125. In one embodiment, the diameter of vertical structures 120, 125 may be the diameter “S”. In certain embodiments, a diameter of one or more vertical structures may be different, for example, vertical structures 120 may have a diameter “S” and vertical structure 125 may have a diameter “C.” In one embodiment, the vertical structures 120, 125 may be solid structures to provided added rigidity, hardness, and durability. In certain embodiments, the vertical structures 120, 125 may be hollow or partially hollow surfaces as needed based on the part/components be secured onto a threaded structure.

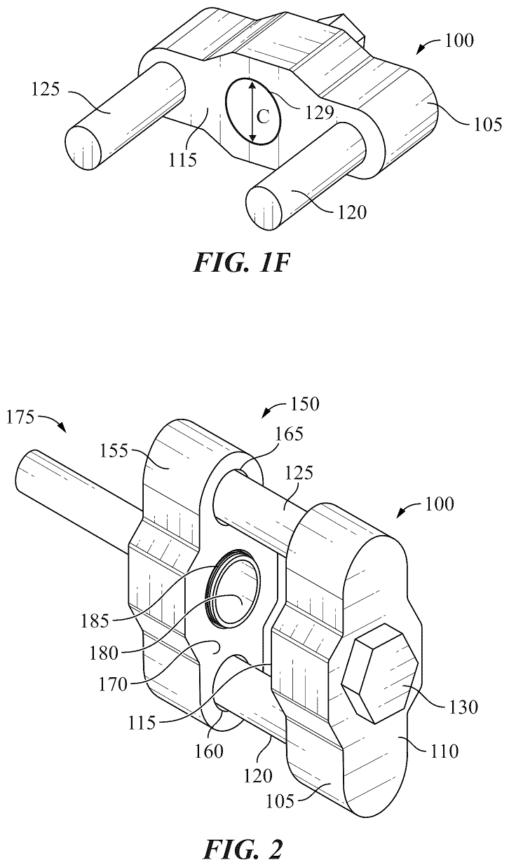

With reference to FIG. 2, one embodiment of the tool of FIG. 1A configured for the hardware component (e.g., flange adapter) of FIG. 1B to loosen or tighten the example hardware component on a threaded pipe will now be described. The tool device 100 is positioned and fitted into the flange adapter 150. The vertical structures 120, 125 may be placed inside the openings 160, 165 of the flange adapter 150 such that the second surface 115 contacts or abuts with the body 155 of the flange adapter 150. The operating feature 130 positioned on the first surface 110 may be turned using a mechanical or electrical tool thereby rotating the housing 105, the vertical structures 120, 125, and the flange adapter 150 onto the threaded surface 185 of the threaded pipe 175. Further, the second surface 115 may include a recess 129 to prevent the second surface 115 from contacting and damaging the threaded end 180 of the threaded pipe 175 while operating the tool device 100.

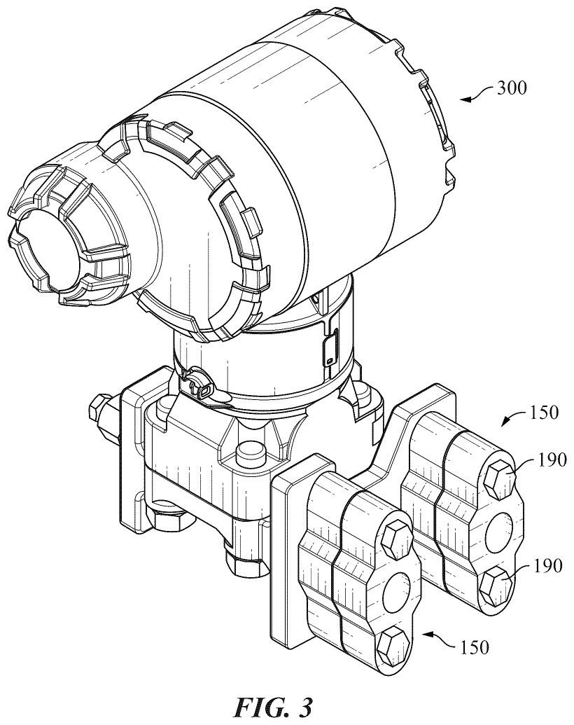

With reference to FIG. 3, one embodiment of the example hardware component (e.g., flange adapter) of FIG. 1B being attached and tightened on an example system such as a pressure transmitter system will now be described. As an example, once the flange adapter 150 is threaded into and secured onto a fitting of a pressure transmitter system 300, bolts 190 may be used to further secure the flange adapters 150 to the pressure transmitter system 300.

### Method of Forming the Tool

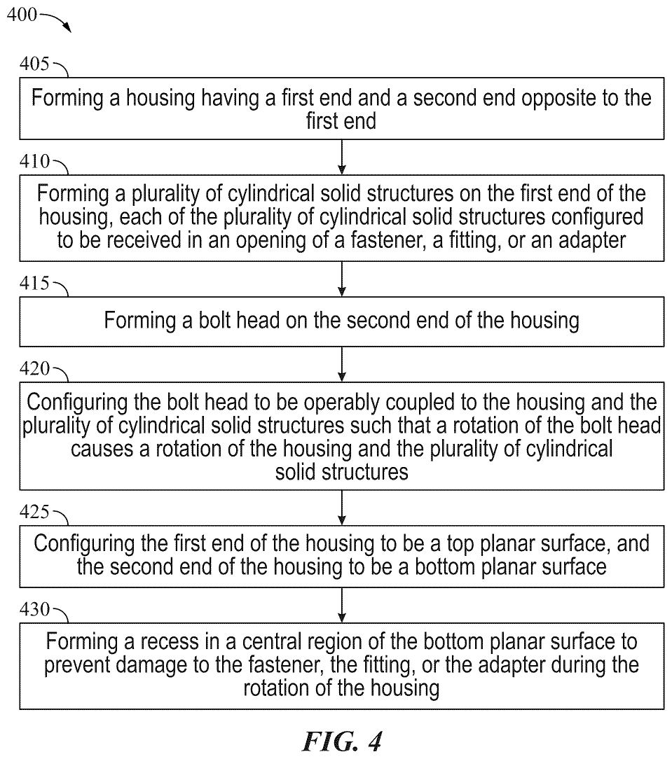

FIG. 4 illustrates one embodiment of a method for making a tool for threaded fasteners, fittings, and adapters described in FIGS. 1A-1F and FIGS. 2-3 that is received into one or more openings of the fitting, adapter, or fasteners to facilitate easy fastening or loosening of the fitting, adapter, or fastener. Each block shown in FIG. 4 may represent one or more processes, methods, or subroutines, carried out in the exemplary method. For explanatory purposes, method 400 will be described with reference to FIGS. 1A-1F and FIGS. 2-3 which shows example embodiments of carrying out the method of FIG. 4 for making a tool for threaded fasteners, fittings, and adapters that facilitates easy fastening or loosening of the fitting, adapter, or fastener. Method 400 may be used independently or in combination with other methods or processes for making a tool for threaded fasteners, fittings, and adapters that facilitates easy fastening or loosening of the fitting, adapter, or fastener.

Method 400 begins at block 405, forming a housing having a first end and a second end opposite to the first end. In block 410, the method includes forming a plurality of cylindrical solid structures on the first end of the housing, each of the plurality of cylindrical solid structures configured to be received in an opening of a fastener, a fitting, or an adapter. In some embodiments, one or more of the plurality of cylindrical solid structures may be formed to vertically extend 1 inch or more from the second end of the housing. In one embodiment, one or more of the plurality of cylindrical solid structures may be made of a magnetic material for securing to the fastener, the fitting, or the adapter. In block 415, the method includes forming a bolt head on the second end of the housing. In one embodiment, the bolt head may be formed such that the diameter of the bolt head is configured to be equal to or less than the diameter of each of the plurality of cylindrical solid structures. In one embodiment, the bolt head may be made of a magnetic material for securing to the fastener, the fitting, or the adapter.

In block 420, the method includes configuring the bolt head to be operably coupled to the housing and the plurality of cylindrical solid structures such that a rotation of the bolt head causes a rotation of the housing and the plurality of cylindrical solid structures. In some embodiments, forming the housing may further comprise of forming lateral exterior surfaces extending between the first and second ends of the housing, and configuring the lateral exterior surfaces to include a surface feature to facilitate a gripping tool or an attaching tool that rotates the housing and forming at least one of an opening for coupling with an attaching tool and one or more protrusions for facilitating grip with a gripping tool as the surface feature. In some embodiments, at least one of the housing, the bolt head, and the plurality of cylindrical solid structures is made of a corrosion and wear resistant material or composite. In certain embodiments, at least one of the housing, the bolt head, and the plurality of cylindrical solid structures is made of a steel or steel alloy.

In block 425, the method includes configuring the first end of the housing to be a top planar surface, and the second end of the housing to be a bottom planar surface. In some embodiments, a recess may be formed in the first end and the bolt head configured to be positioned within the recess, the recess engaging and securing a socket of a socket tool positioned within the recess. In block 430, the method includes forming a recess in a central region of the bottom planar surface to prevent damage to the fastener, the fitting, or the adapter during the rotation of the housing.

### Definitions

Certain terminology is used in the following description for convenience only and is not limiting. Unless specifically set forth herein, the terms “a”, “an” and “the” are not limited to one element but instead should be read as meaning “at least one”. The words “right,” “left,” “lower,” and “upper” designate directions in the drawings to which reference is made. The words “inwardly” or “distally” and “outwardly” or “proximally” refer to directions toward and away from, respectively, the geometric center or orientation of the device, orthodontic hardware and instruments and related parts thereof. The terminology includes the above-listed words, derivatives thereof and words of similar import.

It should also be understood that the terms “about,” “approximately,” “generally,” “substantially” and like terms, used herein when referring to a dimension or characteristic of a component of the preferred invention, indicate that the described dimension/characteristic is not a strict boundary or parameter and does not exclude minor variations therefrom that are functionally the same or similar, as would be understood by one having ordinary skill in the art. At a minimum, such references that include a numerical parameter would include variations that, using mathematical and industrial principles accepted in the art (e.g., rounding, measurement or other systematic errors, manufacturing tolerances, etc.), would not vary the least significant digit.

### Definitions and Other Embodiments

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C. § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. A tool for threaded fasteners, fittings, and adapters, comprising:
a housing having a first end and a second end opposite to the first end;
a plurality of vertical solid structures, each of the plurality of vertical solid structures positioned adjacent to the first end of the housing and configured to extend from the first end to be received in an opening of a fastener, a fitting, or an adapter;
a bolt head positioned adjacent to the second end of the housing and operably coupled to the housing and the plurality of vertical solid structures such that a rotation of the bolt head causes a rotation of the housing and the plurality of vertical solid structures.

2. The tool of claim 1, wherein at least one of the housing, the bolt head, and the plurality of vertical solid structures is made of a corrosion and wear resistant material or composite.

3. The tool of claim 1, wherein at least one of the housing, the bolt head, and the plurality of vertical solid structures is made of a steel or steel alloy.

4. The tool of claim 1, wherein the first end further includes a recess, and the bolt head is configured to be positioned within the recess, the recess engaging and securing a socket of a socket tool positioned within the recess.

5. The tool of claim 1, wherein at least one of the plurality of vertical solid structures extends 1 inch or more from the second end of the housing.

6. The tool of claim 1, wherein the housing further comprises lateral exterior surfaces extending between the first and second ends of the housing, wherein the lateral exterior surfaces are configured to include a surface feature to facilitate a gripping tool or an attaching tool that rotates the housing.

7. The tool of claim 1, wherein the surface feature is configured to be at least one of an opening for coupling with the attaching tool and one or more protrusions for facilitating grip with the gripping tool.

8. The tool of claim 1, wherein the diameter of the bolt head is configured to be equal to or less than the diameter of each of the plurality of vertical solid structures.

9. The tool of claim 1, wherein each of the plurality of vertical solid structures is made of a magnetic material for securing to the fastener, the fitting, or the adapter.

10. The tool of claim 1, wherein the first end of the housing is a top planar surface, and the second end of the housing is a bottom planar surface, and wherein a central region of the bottom planar surface includes a recess to prevent damage to the fastener, the fitting, or the adapter during the rotation of the housing.

11. The tool of claim 1, wherein each of the plurality of vertical solid structures positioned adjacent to the first end of the housing and configured to be received in an opening of a flange adapter.

12. A method for making a tool for threaded fasteners, fittings, and adapters, comprising:
forming a housing having a first end and a second end opposite to the first end;
forming a plurality of vertical solid structures on the first end of the housing, each of the plurality of vertical solid structures configured to extend from the first end to be received in an opening of a fastener, a fitting, or an adapter;
forming a bolt head on the second end of the housing;
configuring the bolt head to be operably coupled to the housing and the plurality of vertical solid structures such that a rotation of the bolt head causes a rotation of the housing and the plurality of vertical solid structures.

13. The method of claim 12, further comprising forming at least one of the housing, the bolt head, and the plurality of vertical solid structures using a corrosion and wear resistant material or composite.

14. The method of claim 12, further comprising forming at least one of the housing, the bolt head, and the plurality of vertical solid structures using a steel or steel alloy.

15. The method of claim 12, further comprising forming a recess in the first end and configuring the bolt head to be positioned within the recess, the recess engaging and securing a socket of a socket tool positioned within the recess.

16. The method of claim 12, wherein forming the housing further comprises forming lateral exterior surfaces extending between the first and second ends of the housing, and configuring the lateral exterior surfaces to include a surface feature to facilitate a gripping tool or an attaching tool that rotates the housing and forming at least one of an opening for coupling with an attaching tool and one or more protrusions for facilitating grip with a gripping tool as the surface feature.

17. The method of claim 12, further configuring the diameter of the bolt head to be equal to or less than the diameter of each of the plurality of vertical solid structures.

18. The method of claim 12, further comprising forming each of the plurality of vertical solid structures to be made of a magnetic material for securing to the fastener, the fitting, or the adapter.

19. The method of claim 12, further configuring the first end of the housing to be a top planar surface, and the second end of the housing to be a bottom planar surface.

20. The method of claim 19, further comprising forming a recess in a central region of the bottom planar surface to prevent damage to the fastener, the fitting, or the adapter during the rotation of the housing.
